(19) United States
(12) Patent Application Publication
(10) Pub. No.: US 2004/0163387 A1
(43) Pub. Date: Aug. 26, 2004

(54) Wave power generator

(76) Inventor: Horacio Pineda, New York, NY (US)

Correspondence Address: HORACIO D. PINEDA, APT. 2710, 320 42nd STREET, NEW YORK, NY, 10017, US

(21) Appl. No.: 10/371,655

(22) Filed: Feb. 24, 2003

(51) Int. Cl. F03C 1/00

(52) U.S. Cl. 60/495; 60/496

(57) ABSTRACT

This hydropneumatic wave power generator, converts the waves, vertical surface displacements into usable electrical or mechanical energy. A fixed cylinder with an open bottom is suspended above the ocean floor in a fixed position. The cylinder top is tightly enclosed except for a “T” shaped air tube opening into the cylinder chamber. This “T” tube houses an intake unidirectional valve on one arm and an exit valve on the other. An intake air tube open to the air and passing through a flywheel equipped air turbine connects to the intake arm of the “T” tube. An exit air tube connected to the exit arm of the “T” tube is likewise connected to the same turbine before it exits to the atmosphere. Air within the wave chamber, above the water, is pushed by a rising wave through the exit valve into the exit tube, which drives the turbine blades to which it is connected. As the wave surface drops, negative pressure created within the chamber closes the exit valve, opens the intake valve, and sucks air from the atmosphere, through the turbine blades and the intake tube, finally filling the wave chamber ready for the next wave cycle.

### BACKGROUND

Wave power is a free and inexhaustible source of energy, which had been studied for many years. While hydroelectric power from dams significantly contribute in supplying useful energy, ocean wave energy, which is markedly more abundant, surprisingly accounts for very little. In the past, several attempts to harness wave energy had been conceived. Movable turbines designed to harness wave impact were proposed by Kumbatovic (U.S. Pat. No. 5,789,826). Wiggs (U.S. Pat. No. 4,725,195) and Kikuchi (U.S. Pat. No. 4,717,831) used paddle wheels and pontoons to extract energy from waves. Ivy (U.S. Pat. No. 4,392,060) converted the vertical wave motion of a float connected to a ratchet geared rack and pinion mechanism to rotate an axle. Azimi (U.S. Pat. No. 5,084,630) designed paddles and hydraulic cylinders in the path of waves to operate a hydraulic pump. Of these devices, Hydropneumatic machines are most relevant to the present invention. Hydropneumatic machines were designed to harness the ebb and flow of tides as well as the vertical movement of the waves to drive air, which is trapped above the water surface, and direct this to drive an air turbine. In nature, this is much like waves pushing columns of air trapped inside submerged lava tubes. Woodman (U.S. Pat. No. 4,098,081), De long (U.S. Pat. No. 145,578), Barwick (U.S. Pat. No. 3,925,986) and Paulson (U.S. Pat. No. 2,484,183) for example, used large tidal chambers to trap air and use tidal motion to make this air to turn turbine blades. Not only were these devices massive, they were also very complex. Hirbod (U.S. Pat. No. 4,266,403), Yim (U.S. Pat. No. 5,499,889) and Tsubota (U.S. Pat. No. 4,258,269) used hydropneumatic principles to drive turbines using cylinders on frames, with floating and fixed members, and a complex set of valves. Despite these many ideas, relatively small amount of our useful energy comes from wave power. The reason for this is because these designs are large, expensive and complex to operate, making them impractical. Since in most locations wave height is not great most of the time, these machines may not be cost effective to build and operate. What is needed is a simple, relatively small, and inexpensive wave power generator, which can operate in areas where wave height is not always large, and simple and inexpensive enough to be installed and operated by ordinary homeowners.

### SUMMARY OF THE INVENTION

The objective of this invention is to harness wave power into mechanical or electrical energy using a small, simplified, inexpensive and improved hyropneumatic engine. A circular, square, triangular or rectangular shaped box, made up of metal, plastic, or pre-cast concrete, totally open at the bottom but enclosed at the top is designed to act as a hydropneumatic cylinder. The enclosed top portion of the cylinder is connected to a “T” shaped valve, which allows air to ingress and egress unidirectionally. The cylinder is lowered into the water and immovably anchored to the sea floor, in such a way that the open bottom is always above the sea floor yet always below the low water mark. The length of the cylinder walls must be such that the closed top end always remain above water even at high tide and rough seas. Thus positioned, the water level within the tube acts as a piston to pull and push air within the cylinder. Since the cylinder is equipped with a one way valve, as water level descends negative pressure within the cylinder opens the intake valve and sucks air from the intake tube, which drives an air turbine, to which it is connected. As the water level ascends it compresses the air within the cylinder pushing open the exit tube, which is also connected, to the same air turbine causing it to turn. The turbine is equipped with a flywheel to keep it rotating through the intake and exit cycles. Since the fixed cylinder has an open bottom allowing free flow of water, tidal and wave changes will be accommodated within the chamber automatically. Regardless of tidal levels, wave height displacement, wave frequency and the internal cylinder area will determine the amount of air ingested and expelled by the engine because of the unidirectional valves. Although this device may be independently anchored to the sea floor, the cylinder size can be designed to be accommodated below existing docks where it can be fixed to the deck posts. For example, two 4 by 8 foot cylinder units can be connected together to drive a small turbine. This cylinder area should displace 64 cubic feet of air on the down stroke and another 64 cubic feet on the upstroke in 1-foot seas. If the wave frequency is 7 waves per minute, this engine can potentially generate 896 cubic feet of air per minute to drive the turbine. The larger the cylinder area, the wave height and the wave frequency, the more powerful the engine becomes. In our example, it is easy to see that everything else being equal, increasing the wave height to two or three feet easily doubles and triples the air displacement which powers the turbine. Unlike some prior art, which mounted their machines in floating platforms, the undulating effects of the platform may actually reduce their machine's efficiency. Their complicated valving and piping systems make operation difficult, at the same time increasing probability of breakdown. Anchoring the device solidly to the sea floor, and providing a unidirectional “T” valve greatly simplifies and improves the machines operation and deployment.

### BRIEF DESCRIPTION OF DRAWINGS

FIG. 1 shows the general configuration and salient parts of the simplified hyropneumatic wave power machine.

FIG. 2 illustrates the wave and air dynamics as well as valve actions when a wave crests within the chamber or cylinder.

FIG. 3 illustrates the wave and air dynamics as well as valve actions when a wave troughs within the chamber or cylinder.

FIG. 4 shows how easily a bank of wave chambers can be anchored onto existing docks

FIG. 5 shows a diagrammatic sketch of a free standing hydropneumatic wave unit anchored and weighed down on the sea floor.

### DETAILED DESCRIPTION OF THE INVENTION

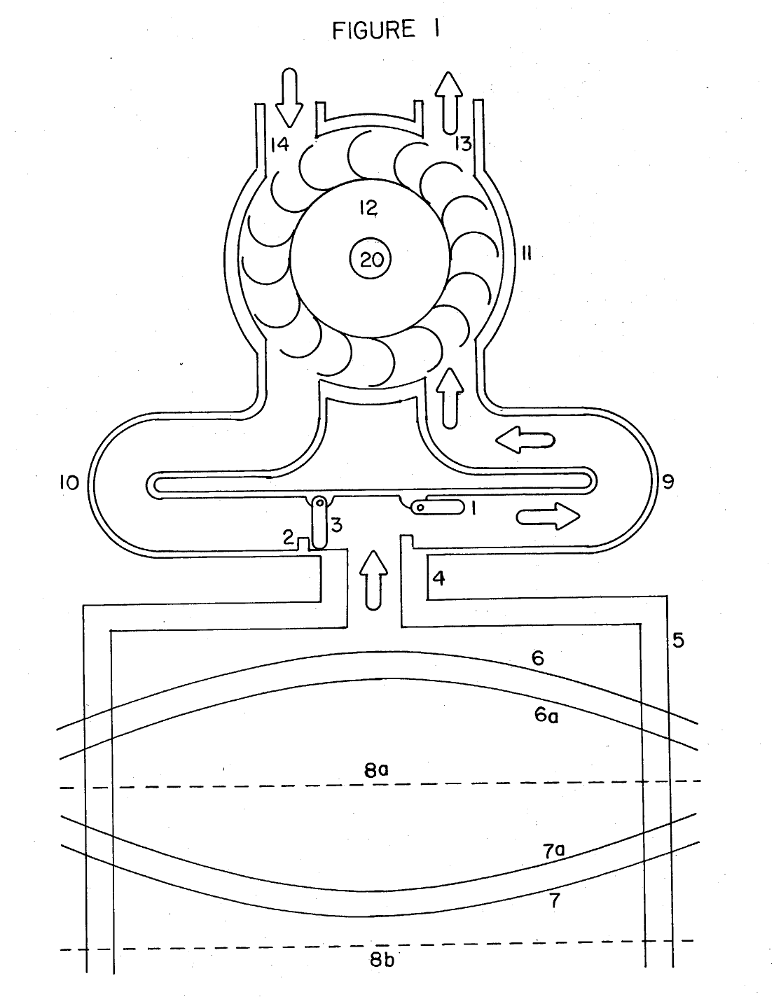

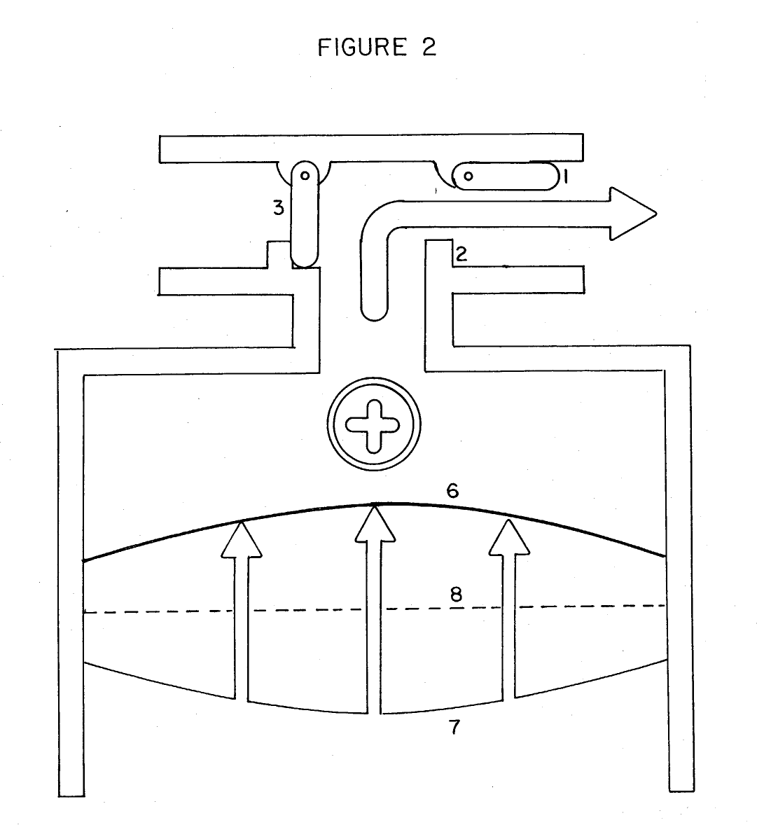

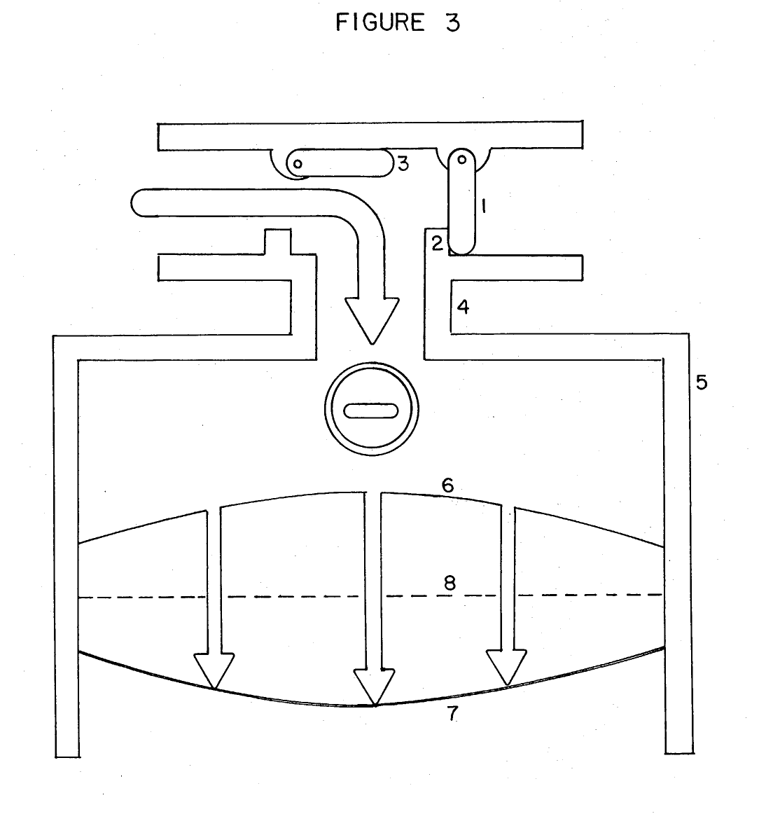

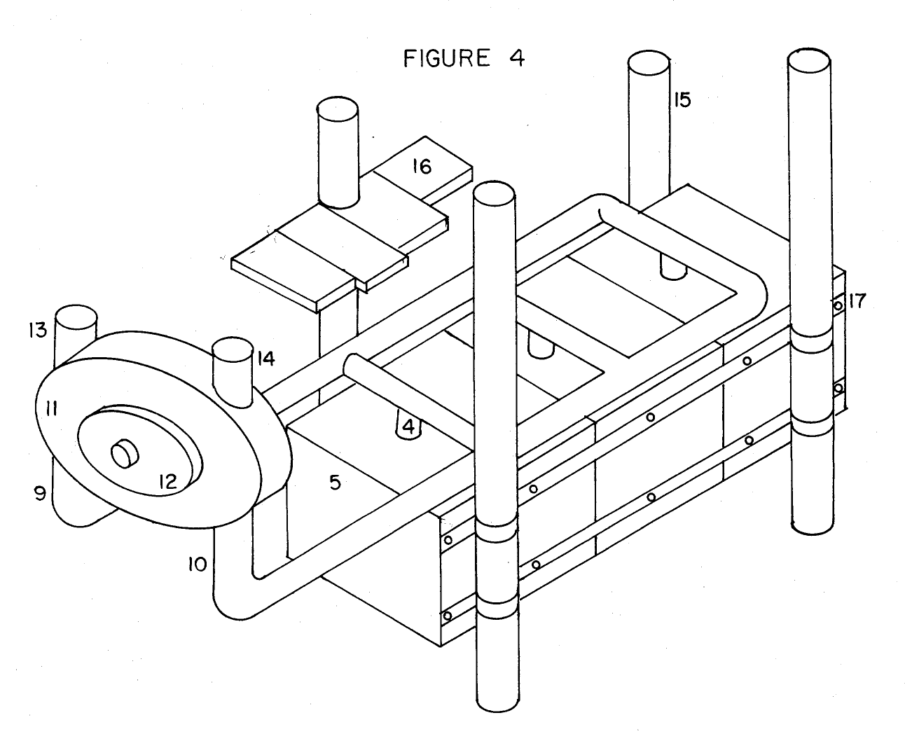

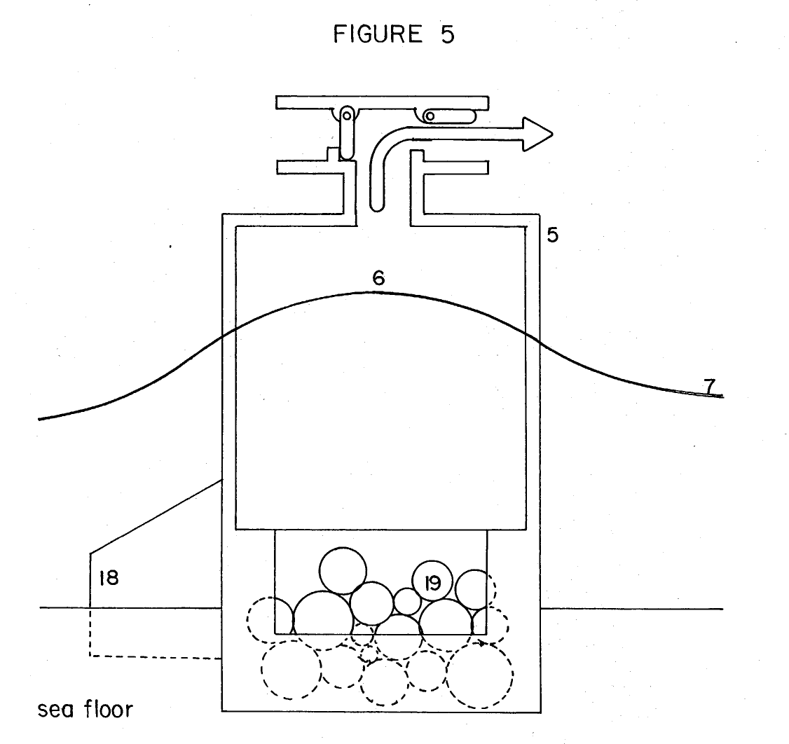

The present invention is an improved and simplified hydropneumatic wave power generator designed to harness wave power and convert it to either electrical or mechanical energy. The device is composed of a wave cylinder made up of a cylindrical metal, composite, or concrete structure (5), totally open at the bottom end and enclosed at the top except for a tubular air duct opening (4). This tubular air duct actually splits into a “T” shaped junction whose arms are equipped with unidirectional valves (1 and 3). One arm equipped with an exit one way valve (1) directs air away from the wave cylinder (5) while the opposite arm, equipped with an intake unidirectional valve (3) direct air into the wave cylinder. These unidirectional valves can be flapper valves, spring-loaded ball valves or reed valves, but the simplest and sturdiest valve design is preferred, to minimize malfunction from fouling or corrosion. The valve seats (2) must be strong and padded with either rubber or composite linings to ensure a leak free and noiseless operation. The exit arm of the air duct is connected to the air turbine (11) by a high-pressure outlet tube (9). The intake arm of the air duct is also connected to the turbine (11) by a negative pressure air inlet tube (10). The intake port (14) and the exhaust port (13) of the turbine are exposed to the atmosphere. Mounted on the turbine axle (20) is a flywheel (12), which serves to improve the turbine's rotation. The placement of the whole devise in the water is critical to the proper functioning of the machine. The devise is designed to be immovably anchored to the sea floor either as a free standing offshore structure (FIG. 5), where it is weighed down by concrete, stone, or metal ballasts (19), or incorporated under docks decking (16 FIG. 4), where it may be fastened (17, FIG. 4) to the pilings (15 FIG. 4). The open end of the wave cylinder must remain above the sea floor to accommodate the free flow of water, but must always remain submerged even at low tide (8b). The cylinder walls must be long enough to keep the enclosed top end as well as the unidirectional air valves (1 and 3) above water, even during large swells at high tide (8a). After proper installation, the devise operates by directing pressurized air within the cylinder (FIG. 2), compressed by a rising wave crest (6 FIG. 2), towards the air tube (4) which automatically closes the intake valve (3) and opens the outlet valve (1). The pressurized air goes through the air outlet tube (9) to drive the turbine (11) and exits out of the exhaust port (13). After cresting, the wave surface begins to descend (FIG. 3). The falling water column creates a negative pressure or vacuum within the cylinder air chamber, which automatically opens the intake valve (3) at the same time closes the outlet valve (1). Consequently, air is drawn into the intake port (14), drives the turbine (11) and directs air into the cylinder through air inlet tube (10). This completes one wave cycle which potentially displaces a volume of air equal to twice the volume of a wave height displacement (shaded area, FIGS. 2 and 3). FIG. 1 also illustrates the automatic self-regulation the devise has with regards to tidal levels and varying wave heights (6, 6a, 7, and 7a). The positive and negative air pressures within the air chamber of the cylinder, which regulate the valve and turbine actions depend solely on the volume of water displace between the trough and crest of a wave (7 and 6), regardless of tidal level conditions (8a and 8b). The open bottom end of the wave cylinder accommodates for both tidal and wave height changes.

I claim:

1. A simplified and improved hydropneumatic wave power generator, designed to harness the energy of the vertical ebb and rise of waves by sucking and pushing air within a fixed, semi-submerged chamber, to and from a common flywheel equipped air turbine via intake and exit tubes equipped with unidirectional valves.

2. The simplified and improved hydropneumatic wave generator described in claim 1, is comprised of a round, square, triangular, or rectangular based cylindrical air chamber, which is designed to be immovably fixed to the sea floor either as a freestanding structure or attached to immovable objects such as submerged rocks or dock pilings.

3. The cylindrical air chamber described in claim 2, fabricated from either metal, composite, reinforced concrete or a combination of materials, is designed to have, a totally open bottom positioned above the sea floor but always remaining submerged below the low water mark, and has a tightly covered top which should always protrude way above the highest wave level even at high tide.

4. The wall height of the cylindrical air chamber described in claim 2, is primarily determined by the mean high and low tidal water marks, as well as the highest historical wave heights recorded in that specific location.

5. The simplified and improved hydropneumatic wave generator described in claim 1, also is comprised of an intake tube which is open
